(19) United States
(12) Patent Application Publication
(10) Pub. No.: US 2025/0156108 A1
(43) Pub. Date: May 15, 2025

(54) METHOD FOR PROVIDING AN ACCESS POINT FOR MEASURING AND CALIBRATING ONE OR MORE FUNCTIONS OF A COMPUTING UNIT

(71) Applicant: Robert Bosch GmbH, Stuttgart (DE)

(72) Inventor: Andreas Achtzehn, Oberstenfeld (DE)

(21) Appl. No.: 18/834,005

(22) PCT Filed: Feb. 10, 2023
(86) PCT No.: PCT/EP2023/053295

§ 371 Date: Sep. 23, 2024

(30) Foreign Application Priority Data
Feb. 11, 2022 (DE) 10 2022 201 452.9

(51) Int. Cl. G06F 3/06

(52) U.S. Cl. CPC G06F 3/0655; G06F 3/0604; G06F 3/0679

(57) ABSTRACT

A method for providing an access point for measuring and calibrating one or more functions of a computing unit. The functions are implemented by executing corresponding computer programs in at least one virtualized execution environment. The virtualized execution environment is provided by a management layer in the computing unit. The management layer is configured to dynamically allocate a relevant memory area to the at least one execution environment. The method includes, using a control module provided in the management layer: receiving one or more access requests via an interface of the computing unit, which requests include identifiers specifying parameters of the one or more functions; determining memory addresses corresponding to the identifiers, taking into account the dynamic memory allocation; and accessing the memory addresses according to the one or more access requests.

### FIELD

The present invention relates to a method for providing an access point for measuring and calibrating one or more functions of a computing unit and to a computing unit and a computer program for carrying out the method.

### BACKGROUND INFORMATION

In the case of control units of machines, e.g., vehicles, parameters of functions provided by the relevant control unit are typically adjusted during a test phase or calibration phase. For example, program variables of a computer program that implements a function are adjusted or changed until a desired behavior is achieved. This procedure is referred to as “measurement and calibration.” In microcontrollers used as or in control units, computer programs and thus their variables are usually stored at fixed memory addresses so that measurement and calibration is possible by read and write access to the known memory addresses of program variables. In the field of microcontrollers, the XCP protocol (universal measurement and calibration protocol) can, for example, be used for this purpose.

### SUMMARY

The present invention relates to a method for providing an access point for measuring and calibrating one or more functions of a computing unit and to a computing unit and a computer program for carrying out the method. Advantageous example embodiments of the present invention are disclosed herein.

The present invention relates to functions which are provided in a virtualized form or environment, i.e., it relates to functions which are implemented by executing corresponding computer programs in at least one virtualized execution environment (e.g., virtual machine), wherein the at least one virtualized execution environment is provided by a management layer (e.g., hypervisor) in the computing unit. The management layer is configured to dynamically allocate a relevant memory area to the at least one execution environment.

The present invention makes use of the measure, by means of a control module provided in the management layer, of receiving, via an interface of the computing unit, one or more access requests, which include identifiers specifying parameters (function parameters) of the one or more functions and of determining memory addresses corresponding to the identifiers. The memory addresses are determined by taking into account the dynamic memory allocation. The determined memory addresses are accessed according to the one or more access requests. Access is thus made possible even though the dynamically allocated memory areas or corresponding memory address spaces are not known outside the computing unit or the management layer, and without each function having to implement its own functionality for measurement and calibration, i.e., its own access point. Accordingly, the measurement and calibration of multiple functions can advantageously take place by means of the same access point, which is formed by the control module.

The term “function” is to refer in general to a functionality implemented by the computing unit. For example, this functionality is the regulation or control of an external device (e.g., motor) by the computing unit and using sensor data (e.g., rotational speed or electrical current intensity). The external device is controlled and sensor data are received via suitable interfaces of the computing unit.

The term “parameter” or “function parameter” refers in general to a parameter of a function, a variable of a function, data used by the function, measured values received by the function, or the like. Function parameters are typically stored in a memory portion of the function. If the function implements a controller, for example, constants (gain factors) of the controller and the measured value (actual value) of a variable to be controlled can represent function parameters. By reading the measured value (e.g., rotational speed in the example above) and possibly other variables (e.g., current intensity for controlling the motor or manipulated variables) via the access point, it can be checked during measurement and calibration whether the controller is functioning as desired, and the behavior of the controller can be adjusted by changing the parameters (gain factors) of the controller in a write access.

Accessing the memory addresses according to the one or more access requests is to be understood in a general sense. In particular, it may comprise reading memory contents of the memory addresses and/or writing data to be written to the memory addresses. Furthermore, accessing according to the one or more access requests may also comprise transmitting or sending read data via the interface. An access request may also include the request to read a function parameter at multiple particular points in time. In this case, accessing according to the one or more access requests may also comprise reading the memory addresses at these multiple particular points in time and transmitting or sending respectively read data via the interface.

The “control module” as well as the “proxy module” or “intermediary module” introduced below are in particular implemented by executing one or more corresponding computer programs, wherein individual elements (steps or sub-steps) can also be implemented at least partially by specific hardware units. Such hardware units can, for example, be provided to support virtualization (management layer, execution environments), to translate addresses, or the like. The control module could also be referred to as a measurement and calibration module or measurement and calibration controller. The proxy module could also be referred to as a measurement and calibration proxy.

The memory addresses being determined by taking into account the dynamic memory allocation means that, for each access request, the dynamically allocated memory area, or the mapping between actual memory addresses and execution environment-specific (virtual) memory addresses of the execution environment in which the function to which the relevant access request relates is implemented (i.e., to which function parameters the relevant access request relates), is taken into account.

The memory addresses relate to an actual address space of a memory, in particular working memory, of the computing unit. (When started by the management layer) each execution environment is allocated a memory area of the memory that corresponds to a sub-area of the actual address space. Each execution environment uses (execution environment-specific) virtual or logical addresses (memory addresses), which are converted into corresponding actual addresses, in particular by the management layer, during memory access. Execution environments generally cannot access memory areas of other execution environments.

The identifiers make it possible to determine the actual memory addresses of the specified function parameters. The identifiers in particular include information regarding memory locations of the relevant function parameters and/or symbol names and/or the like. In addition, information available in the management layer, i.e., in particular the dynamic memory area allocation to the execution environments, is also taken into account. The identifiers preferably include information regarding the function to which the parameters (function parameters) relate and/or regarding the execution environment in which this function is implemented. This information may also be taken into account in the determination of the actual memory addresses (in particular when using a proxy module). This makes it possible to accurately specify the function parameters and hence to determine the corresponding memory addresses.

Preferably, according to an example embodiment of the present invention, the method comprises recording, by means of a proxy module provided in an execution environment, execution environment-specific addresses of functions executed in the relevant execution environment, and/or of the function parameters thereof; and determining, by means of the control module, the memory addresses corresponding to the identifier by taking into account the dynamic memory allocation and the execution environment-specific addresses. Execution environment-specific addresses indicate the position of the function and/or the function parameters relative to the memory area allocated to the execution environment, i.e., in a virtual address space of the execution environment. This embodiment is useful when an address range in the virtual address space of the execution environment is dynamically allocated to a function by an execution environment, since the execution environment-specific address of the function and thus of the parameters thereof can in this case vary between different executions of the function and/or of the execution environment (e.g., between different starts of the computing unit).

Preferably, according to an example embodiment of the present invention, the method comprises receiving, by means of the control module, the one or more access requests relating to a particular function implemented in an execution environment in which the proxy module is provided, at a point in time when a particular computer program, the execution of which implements the particular function, is not yet being executed; transmitting, by means of the control module, a function start request for the particular function to the proxy module in response to receiving the one or more access requests; initiating, by means of the proxy module, the start of the particular computer program in response to the function start request; and accessing, by means of the control module, the memory addresses according to the one or more access requests as soon as the particular computer program is being executed. This embodiment makes it possible to measure and calibrate functions which are not yet being executed at a point in time when the measurement and calibration are to take place.

Preferably, according to an example embodiment of the present invention, the method comprises receiving, by means of the control module, the one or more access requests relating to function parameters of a function implemented in an execution environment which has not yet been provided or started; waiting until the execution environment is provided or started; and subsequently accessing the memory addresses according to the access requests. This makes it possible to process access requests that are relevant or relate to the (desired) implementation of functions during a start-up phase.

A computing unit according to the present invention, e.g., a control unit of a vehicle, is configured, in particular in terms of a program, to carry out a method according to the present invention.

Furthermore, according to an example embodiment of the present invention, the implementation of a method according to the present invention in the form of a computer program or computer program product having program code for carrying out all the method steps is advantageous because it is particularly low-cost, in particular if an executing control unit is also used for further tasks and is therefore present anyway. Finally, a machine-readable memory medium is provided with a computer program as described above stored thereon. Suitable memory media or data carriers for providing the computer program are, in particular, magnetic, optical, and electric memory media, such as hard disks, flash memory, EEPROMs, DVDs, and others. It is also possible to download a program via computer networks (Internet, intranet, etc.). Such a download can be wired or wireless (e.g., via a WLAN network or a 3G, 4G, 5G or 6G connection, etc.).

Further advantages and embodiments of the present invention can be found in the description and the figures.

The present invention is shown schematically in the figures on the basis of exemplary embodiments and is described below with reference to the figures.

### BRIEF DESCRIPTION OF THE DRAWINGS

FIG. 1 shows functions implemented in execution environments, and access points provided by a management layer for measurement and calibration according to a preferred embodiment of the present invention.

FIG. 2 shows a flow chart according to a preferred embodiment of the present invention.

### DETAILED DESCRIPTION OF EXAMPLE EMBODIMENTS

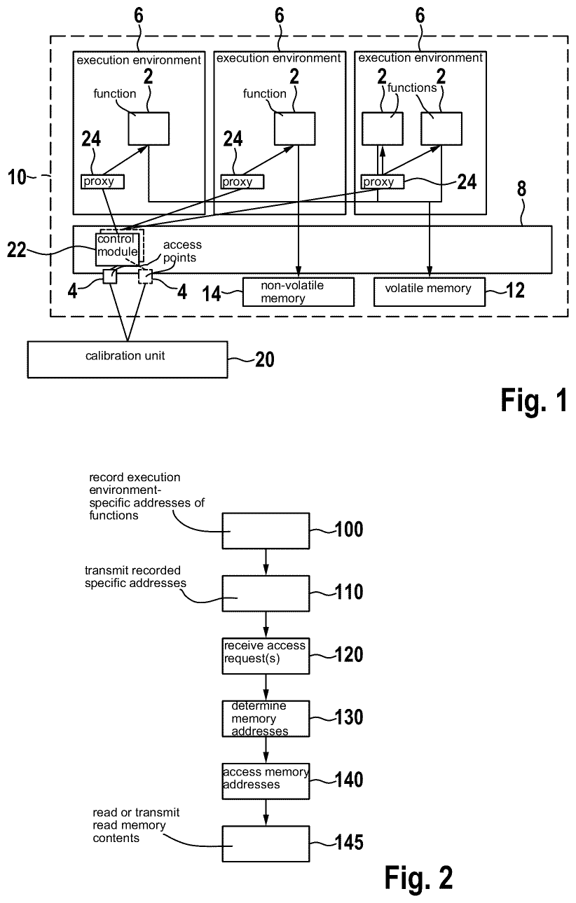

FIG. 1 shows functions 2 implemented in execution environments 6 by executing corresponding computer programs, and access points 4 provided by a management layer 8 for measurement and calibration of the functions according to a preferred embodiment.

The functions 2 are provided in a computing unit 10, e.g., a control unit of a machine, in particular a vehicle, in so-called virtualized form and are implemented as computer programs, which are executed in the execution environments 6. The execution environments 6 themselves are likewise computer programs, which (from the perspective of the functions) each represent a particular (virtual) environment (e.g., hardware and/or operating system and/or software environment). The computing unit comprises hardware, in particular one or more processors and memories, in which the described execution environments 6 and the management layer 8 are implemented.

The execution environments 6 are provided by the management layer 8 (i.e., started and subsequently managed while being executed). The management layer 8 in particular implements the execution environments, i.e., the virtual environments, within the framework of the actual environment (host system), i.e., within the framework of the computing unit 10 and any host operating system executed thereon. In other words, the execution environments are respectively presented with their own complete guest computing unit with all hardware elements (processor, drives, working memory, etc.) (which can be different for different execution environments). These guest computing units are generally different from the computing unit 10 (host computing unit). This can in particular take place through hardware emulation, hardware virtualization or paravirtualization. The execution environments 8 are, for example, so-called virtual machines or containers. The management layer 8 is, for example, a so-called hypervisor (type 1 or type 2).

The execution environments 6 and the functions 2 typically do not have direct access to the hardware resources of the computing unit 10 but can only access them via the management layer 8. This applies in particular to accessing the memory (volatile memory 12, non-volatile memory 14). Each of the execution environments 6 is allocated a memory area, or memory area in the volatile memory 12 and/or non-volatile memory 14, by the management layer 8. This allocation takes place dynamically, for example when the relevant execution environment is started. Virtual addresses of the execution environment, i.e., in a (virtual) address space from the perspective of the execution environment, are mapped by the management layer to actual addresses in the memory, i.e., to an actual address space corresponding to the allocated memory area. The actual address space can be a physical address space or a logical address space. The latter may, for example, be the case if the management layer is built on a host operating system, such as in the case of a type 2 hypervisor.

Access to interfaces of the computing unit 10 for data communication with external devices from the execution environments also takes place via the management layer 8. In the case of a control unit, the external devices can in particular be devices to be controlled (such as motors, actuators, or the like) and/or sensors.

In order to read and/or write parameters or variables of the functions during measurement and calibration, at least one access point 4 is provided, via which an external measurement and calibration unit 20 (measurement technology, e.g., a computer) can access (read and/or write) the function parameters. For this purpose, at least one interface (e.g., corresponding to the at least one access point) for data communication is provided on the computing unit. The interface is, for example, a CAN interface (CAN: controller area network), an Ethernet interface, a USB interface, an SPI interface (SPI: serial peripheral interface) or any other serial interface. The communication can take place by means of a corresponding interface protocol.

In the management layer or in addition to the management layer, a control module 22, i.e., a computer program module, is provided, which is configured to communicate via the at least one access point or the corresponding at least one interface, i.e., to receive and send data. The control module 22 is configured to receive access requests, e.g., from the external measurement and calibration unit 20. Access requests are read and/or write requests that relate to particular function parameters. In order to specify the function parameters, the access requests comprise identifiers by means of which the relevant function parameter is uniquely defined or can be determined. Identifiers comprise in particular names or symbols or the like that specify function parameters in relation to individual functions. Furthermore, the identifiers can comprise information by means of which the function of which the function parameters are to be accessed can be determined and/or by means of which the execution environment in which the function of which the function parameters are to be accessed is executed can be determined.

The control module 22 is furthermore configured to use the identifiers to determine memory addresses at which the corresponding function parameters are stored and to access the determined memory addresses according to the access request. The determined memory addresses here are actual memory addresses within the memory areas allocated to the execution environments.

In the simplest case, the functions, and thus the function parameters, are located at preknown positions within the relevant execution environment. This corresponds to the situation of a microcontroller in which the software is stored at known memory addresses; such an execution environment would virtualize a microcontroller, so to speak. In relation to the (virtual) address space of an execution environment, it is in this case preknown at which (execution environment-specific) addresses the function parameters are located. The preknown execution environment-specific addresses are converted by the control module into corresponding actual memory addresses by taking into account the dynamic memory allocation to the execution environment. Taking the dynamic memory allocation into account means that the mapping between the virtual address space and the actual address space is used; execution environment-specific addresses are mapped to corresponding actual memory addresses. The preknown execution environment-specific addresses can be stored by the control module and/or comprised in the identifiers; in particular, it is possible that the identifiers are substantially the preknown execution environment-specific addresses.

In the further case, functions, or the computer programs which implement the relevant functions, are dynamically started and executed in an execution environment at runtime (this corresponds, for example, to the situation in which a guest operating system is executed in the execution environment). In this case, the execution-specific addresses of a function and of the function parameters thereof are typically not preknown but can be different for different executions. The address information on the execution-specific addresses at which the function and/or function parameters are located is in this case initially only known to the execution environment. In order to make this address information available in the control module as well, a proxy module 24 (i.e., a program module) is preferably provided in at least one corresponding execution environment, which proxy module records this address information and makes it available to the control module. As soon as a function is being executed, the information can be transmitted to the control module, which stores it, and/or the address information can be transmitted to the control module in response to a corresponding query from the control module. In the first case, when the execution of a function is terminated, the proxy module can additionally transmit corresponding information to the control module, which can delete the address information relating to this function or mark it as no longer valid. In the second case, if the address information does not relate to the execution environment-specific address of the function, the query can specify for which function parameters the address information is to be transmitted. If the address information relates to the execution environment-specific address of the function, it may be known to the control module, i.e., it may have been stored by the control module or it may have been transmitted, together with the access request (e.g., comprised in the identifiers), to the control module, at which environment-specific addresses the function parameters are located in relation to the environment-specific address portion occupied by the function (for example in relation to an environment-specific start address of the function).

In order to determine the actual memory address at which a function parameter is stored, the control module 22 takes into account not only the dynamic memory area allocation to the execution environment but also the address information from the proxy module 24.

Furthermore, the proxy module 24 can be configured to start or to initiate the start of the execution of functions in the relevant execution environment. This in particular takes place in response to a corresponding function start request from the control module 22. The control module can thus initiate the start or the execution of a particular function by using a proxy module. This option is, for example, helpful if a function that, normally, for example during normal operating states of a machine which comprises the computing unit 10 as a control unit, is only rarely or not at all executed is to be measured and calibrated.

FIG. 2 shows a flow chart according to a preferred embodiment.

The assumption for the steps shown is, or steps not shown are, that a management layer (e.g., hypervisor) is executed in the computing unit and provides at least one execution environment (e.g., virtual machine or container) in which the functions are implemented. The management layer, the execution environments and the functions are each implemented by executing corresponding computer programs, possibly by using specific hardware units.

In the preferred step 100, i.e., in particular assuming that a proxy module is provided, the proxy module records execution environment-specific addresses of functions executed in the relevant execution environment and/or of the function parameters thereof. In the likewise preferred step 110, the recorded specific addresses are transmitted to the control module. As explained above, this can take place as soon as a function is started and/or in response to a corresponding query by the control module (in the second case, this step obviously only takes place after step 120).

In step 120, the control module receives one or more access requests via an interface of the computing unit. These access requests include identifiers that indicate parameters (function parameters) of the one or more functions.

In step 130, the control module determines memory addresses corresponding to the identifiers by taking into account the dynamic memory allocation. If a proxy module and, accordingly, execution environment-specific addresses are used (steps 100, 110), the execution environment-specific addresses are additionally taken into account in the determination of the memory addresses. In this case, see step 110, the execution environment-specific addresses can be read from a memory assigned to the control module and/or can be queried from the proxy module by means of a corresponding query.

In step 140, the memory addresses are accessed according to the one or more access requests. Optionally, in the case of a read access request, in step 145, which can also be regarded as part of the access (step 145), read memory contents are sent or transmitted via the interface to the external device (e.g., the external measurement and calibration unit 20) that has sent the access request.

1-10. (canceled)

11. A method for providing an access point for measuring and calibrating one or more functions of a computing unit, the functions being implemented by executing corresponding computer programs in at least one virtualized execution environment, wherein the at least one virtualized execution environment is provided by a management layer in the computing unit, wherein the management layer is configured to dynamically allocate a respective memory area to the at least one execution environment, the method comprising the following steps, using a control module provided in the management layer:
receiving one or more access requests via an interface of the computing unit, the requests including identifiers specifying parameters of the one or more functions;
determining memory addresses corresponding to the identifiers by taking into account the dynamic memory allocation; and
accessing the memory addresses according to the one or more access requests.

12. The method according to claim 11, comprising the following steps:
recording, using at least one proxy module provided in the at least one execution environment, execution environment-specific addresses of functions executed in the respective execution environment and/or of the function parameters of the function executed in the respective execution environment; and
determining, using the control module, the memory addresses corresponding to the identifiers by taking into account the dynamic memory allocation and the execution environment-specific addresses.

13. The method according to claim 12, further comprising the following steps:
receiving, using the control module, the one or more access requests relating to a particular function implemented in an execution environment in which a proxy module is provided, at a point in time when a particular computer program, the execution of which implements the particular function, is not yet being executed;
transmitting, using the control module, a function start request for the particular function to the proxy module in response to receiving the access requests;
initiating, using the proxy module, a start of the particular computer program in response to the function start request; and
accessing, using the control module, the memory addresses according to the one or more access requests as soon as the particular computer program is being executed.

14. The method according to claim 11, further comprising, using the control module, the following steps:
receiving the one or more access requests relating to function parameters of a function implemented in an execution environment which has not yet been provided or started;
waiting until the execution environment is provided or started; and
after the execution environment is provided or started accessing the memory addresses according to the one or more access requests.

15. The method according to claim 11, wherein the one or more access requests include a read request, wherein the accessing of the memory addresses includes:
reading a memory content of the memory addresses corresponding to the identifiers; and
transmitting or sending the read memory content via the interface.

16. The method according to claim 11, wherein the one or more access requests include a write request and data to be written, wherein the accessing of the memory addresses includes:
writing the data to be written to the memory addresses corresponding to the identifiers.

17. The method according to claim 11, wherein the identifiers include information regarding the at least one or more functions to which the parameters relate and/or regarding the execution environment in which the one or more functions is implemented.

18. A computing unit configured to provide an access point for measuring and calibrating one or more functions of the computing unit, the functions being implemented by executing corresponding computer programs in at least one virtualized execution environment, wherein the at least one virtualized execution environment is provided by a management layer in the computing unit, wherein the management layer is configured to dynamically allocate a respective memory area to the at least one execution environment, the computing unit, using a control module provided in the management layer, configured to:
receiving one or more access requests via an interface of the computing unit, the requests including identifiers specifying parameters of the one or more functions;
determining memory addresses corresponding to the identifiers by taking into account the dynamic memory allocation; and
accessing the memory addresses according to the one or more access requests.

19. A non-transitory machine-readable memory medium on which is stored a computer program for providing an access point for measuring and calibrating one or more functions of a computing unit, the functions being implemented by executing corresponding computer programs in at least one virtualized execution environment, wherein the at least one virtualized execution environment is provided by a management layer in the computing unit, wherein the management layer is configured to dynamically allocate a respective memory area to the at least one execution environment, the computer program, when executed on a computing unit, causing the computer unit to perform the following steps, using a control module provided in the management layer:
receiving one or more access requests via an interface of the computing unit, the requests including identifiers specifying parameters of the one or more functions;
determining memory addresses corresponding to the identifiers by taking into account the dynamic memory allocation; and
accessing the memory addresses according to the one or more access requests.
